(19) United States
(12) Patent Application Publication
(10) Pub. No.: US 2002/0194029 A1
(43) Pub. Date: Dec. 19, 2002

(54) Method and apparatus for improved patient care management

(76) Inventors: Dwight Guan, Riverside, CA (US); Shing H. Doong, Pingtung City (TW)

Correspondence Address: LEVIN & HAWES, P O BOX 4140, LAGUNA BEACH, CA, 92652

(21) Appl. No.: 09/883,754

(22) Filed: Jun. 18, 2001

(51) Int. Cl. G06F 17/60

(52) U.S. Cl. 705/3

(57) ABSTRACT

A medical care management system is disclosed having a database of patient information including medical history records, comprising a medical record input apparatus; a medical record storage apparatus; a medical record viewing apparatus; a means for automatically scrolling the medical record being displayed by the medical record viewing apparatus; and a comment input apparatus receiving comments from a user of the system relating to the medical record being displayed, and inputting the comments into the medical records storage apparatus linked to the medical record being displayed. The system can further comprise a patient information input information apparatus; and linking means for linking the patient information to at least one stored medical record.

### FIELD OF THE INVENTION

The present invention relates to the field of patient care and specifically medical record keeping, including initiation and maintenance.

### BACKGROUND OF THE INVENTION

In the physician's office of today, the focus is typically on office management which is oriented around and designed towards the scheduling, billing, prescription of medication and record keeping in regard to all of these, including patient charting, in a more or less paper environment. There do exist today software packages for the physician, hospital and other health care provider, such as “Health Measures,” and “Wireless Technology.” Some of these involve the integration of physician and patient scheduling, staff scheduling, treatment coding and billing, as well as such things as prescription documentation, recording and filling. In some cases these packages involve the ability to access patient records maintained by a service provider in a remote location and accessible over the Internet from the physician's office, with proper authorization. These systems can enable the physician to maintain databases regarding current patient information, as well as obtain patient information for new patients, e.g., from other health care providers.

The healthcare industry is in search of a better way to access and interpret and/or update patient medical data at the point of care, with greater charting input, interpretation and modification flexibility. There is a need for the ability to receive, relay, update and modify patient information, including charted information, in a more efficient, accurate and timely manner. The challenge of managing large numbers of patients through ongoing episodes of treatment, often for a variety of different ailments and conditions, often also across numerous different providers of health care services, sometimes at multiple venues of the provision of such health care services, demands greater coordination of access to information and records, in addition to simply coordinating the clinical services and the managing and handling of financial services. Improvements in the integration of automated systems at the point of care is becoming more and more of a necessity for proper and adequate care as well as for cost effectiveness and avoidance of improper/unnecessary care or treatment.

FoxMed™ provides a system that is capable of integrating medical practice management and managed care tasks, utilizing “Microsoft's” database development/management environment, and Windows™ platform, operating in Windows 95™, Windows 98™ and Windows NT™. The system of the prior art provides managed care functionality. FoxMed™, allows the integration of numerous insurance plans. Various fee schedules can incorporate, e.g., relative value scale with conversion factors per code or per code category. Code categories according to this system can be user-definable, e.g., Evaluation and Management, Medicine, Surgery, Radiology, Anesthesia, etc. FoxMed™ can implement vital managed care segments of reporting. The reports can include the assembly of information to assist in managing a practice, e.g., in managed care environments. These can include Service Analysis calculation, Capitation Analysis calculation, Fee Schedule and Plan Analysis calculation, Expense Analysis calculation, Payer Mix Analysis calculation, and Reimbursement Analysis calculation. The system includes gate-keeper and authorization functions and provides tracking of information including tracking patient visits and treatments by category. FoxMed™ can allow fast and efficient posting of insurance and family checks to many invoices or claims across many patient accounts, all from one screen. FoxMed™ integrates patient scheduling to provide a schedule for each health care provider including the physicians. The system also provides for activity graphing for a visual presentation of the patient scheduling. Also provided is access to patient treatment entries, as well as many other daily tasks. The system also provides for electronic insurance claims processing and for billing and accounting functionalities that are automated. FoxMed can also provides a series of Management Reports, e.g., Daily and Monthly Activity and Posting Reports, Bank deposit reports for balancing, Procedure and Diagnosis Tracking for historical analysis, Revenue reports by procedure, carriers, providers, etc., Complete Managed Care tracking of procedures, payments and practice analysis.

Another example of prior art automation in the medical environment includes Chart-It & Probe OneTM FoxDent.™ This integration of Chart-It & Probe One™ is utilized in providing dental case and can enable the production of dental charting and the incorporation and/or attachment of statistical, comparison and other reports to the charts, along with the inclusion of patient history information with the charts. Probe One's includes automatic recording of data in real time as the dentist does an examination and makes findings that are to be incorporated into the chart. This is done utilizing instruments that are electronically ties to a database, and can include computer generated voice call out of the instrument measurements being so stored.

Another example of medical practice automation is WebMD, a integrated healthcare automation solution, provided by Medical Manager Health Systems. This physician practice management system has the ability to address financial, administrative, clinical and practice management needs of healthcare providers. The system is suitable for use by physician groups, MSOs, IPAs, independent physicians, MCOs and other providers. The system can manage the business and clinical aspects of the physician practice. A feature of this system includes an appointment scheduler, including waiting lists, appointment tracking, a full-month display calendar, extended comment fields, and multiple-resource searches and displays. The system can generate recall notices to remind patients to schedule appointments. The system is capable of managing financial information, such as accounts receivables, financial history, and billing, and can process insurance payment. The system has the capability of automatically assembling necessary information and placing it into appropriate insurance company forms automatically, and automatically processes the fees, rules, and requirements of various types of insurance. The system can also track and record clinical history, storing practice-defined patient clinical data; and office notes, facilitating free-form patient comments. Such notes can be electronically stamped with the time, date and user on each note. Procedure and diagnosis history, e-mail, hospital rounds information, referring physician information, can be recorded and accessed, e.g., via generated reports. The system also provides for office management systems, including scheduling of health care providers and needed equipment, tracking patient encounters, recovering physical patient charts from indicated storage locations, e.g., on a daily batched basis, for all scheduled patients for that particular day, e.g., by tracking the last known location for the particular record or chart and an audit trail of its most recent locations, etc. The system also includes a billings and collections automation capability.

Still another example of the prior art includes EmedPractice, a Web enabled solution provided by Medscape.com, a medical office management web site including electronic claims submission capabilities and other tools to assist in running a physician's office. The system can enable the on-line submission of insurance claims electronically or printed automatically for carriers that will not accept electronic submissions.

edgemed.com is still another example of available automated medical practice systems, which includes stored diagnosis files, encounter and treatment notes, including free form notes for emergency contact, provider, patient, and nurse, the ability to track referrals into and out of practice, reporting capabilities, insurance processing, automatic printing of chart labels, and billing functions. The system provides for access by name, account number, chart number, phone number, or social security number. The system also tracks appointments and scheduling. The system provides for the utilization of progress notes.

Another prospective provider of such services over the web UnwiredDr.com (formerly Physix) has indicated that it will be on the Web with wireless Web services for physicians that will allow physicians to chart online, prescribe medications, dictate notes, and check lab results, utilizing the power of the wireless Internet, e.g., with cellular phones, pagers and hand-held computers. The unwiredDr wireless service, contemplated by UnwiredDr.com, supposedly will, will enable physicians to renew and fill patient prescriptions, check lab results remotely and dictate into their cellular phone and permanently store their transcribed notes in the patient's medical record. The proposed system is said to be able to provide for an online, central source for patient data. The system is said also to be able to provide Internet-based charting tool for physicians, with the ability to generate a complete patient record, which can facilitate the reduction of evaluation and management coding inaccuracies. The system is also said to be able to allow customization and for point and click navigation through information regarding most frequently used exams, medications, and treatment guidelines, in order also to assist in chart management efficiency and reduced transcription costs. The system is said to include WebChart, a Web-based clinical documentation tool and an online, central information source for patient data. According to the Website as it currently exists, a physician can access patient records from any Internet connected computer, or other compute engines that are Internet compatible, e.g., cell phones, personal assistants, palm pilots and the like. The system is said to generate a patient record for the patient visit and automatically calculates the appropriate E&M codes, ensuring documentation to support subsequently billed charges for that visit. The system is also said to be capable of capturing and printing patient records, eliminating the need for a transcriptionist. The captured information can be sent to a referring physician. Basic patient information is also recorded and stored on the Web-site according to a form that the patient completes on the first visit, including, e.g., the chief complaint, history of present illness and current medications and allergies, and can be accessed by the physician in the treatment room electronically. The system is also capable of enabling patients to fill and refill prescriptions on-line. The system can enable the physician to access a patient records remotely, e.g., from home or when at the hospital, e.g., to visit a patient whose records are desired to then be viewed. This can include such viewing simply from the physician's examination/treatment room in the physician's office.

Another system on the market is Pocket Chart™ by Data Critical Corporation, which is said to provide electronic chart and record access for utilization at the point-of-care and providing electronic medical record access through, e .g., wireless communication devices such as palm pilots and the like. The system is said to enable physicians to document patient visits with greater precision and increased productivity that enable the production of HCFA-compliant chart notes through hand held input, such as simple taps of the pen. The system is said to allow for data sharing among multiple clinicians in an office or in an otherwise networked setting. The system is said to create formatted, printable note from data entries, and eliminate the need for additional transcription. The system is also said to enable access to drug related databases for purposes of writing prescriptions and enable printing out of such prescriptions. The system is said to work in conjunction with desk top or other computing systems that can be utilized to download the chart/record data to the hand held device used by the physician. The system is said to eliminate such problems with using paper records and charts as the omission of critical information and/or the presence of illegible writing which can be barriers to receiving payment, e.g., from Medicare and insurance companies. The system is said to facilitate the production of patient notes that are more complete, are compliant with HCFA requirements, and legible.

Another example of access to medical information over the Internet can be found in Mobile View, a product which is said to enable the collection of patient monitoring data from a remote location, e.g., a hospital where the patient is currently undergoing treatment, by accessing the data through wireless communication, e.g., a cell phone or other wireless communication device.

### SUMMARY OF THE INVENTION

The present invention solves the shortcomings of the prior art systems by providing an innovative and simple to use medical office management and patient care and monitoring system, which is in addition more efficient and effective than known systems. The system of the present invention provides the physician and the physician's staff with an improved mechanism for providing high quality patient care. The present invention provides a simple and easy to use user interface to digitized medical records through audio and/or image access and input capability, which, in addition can be made to have portable/remote electronic access and update capabilities, better integration with medical office staff, management and patient care records and functions and in a manner that provided increased cost effectiveness. The present invention serves to facilitate point of care decision making through the use of electronically accessible integrated patient records and information, with a streamlined record entry and access process. In addition this will increase the accuracy and reliability of patient record documentation entries and updates, and such things as treatment coding, e.g., for insurance purposes. The system also facilitates the sharing of information and records between physicians at a particular location, in remote offices, e.g., for referrals to specialists, and with hospitals and other patient treatment/rehabilitation centers, and in addition, with pharmacies, insurance providers, etc. The system of the present invention provides for greater flexibility of physician staff utilization and increases time effectiveness of the staff, and is readily accessible to and compatible with presently existing medical record databases, including on-line databases, e.g., “MedicalLogic.” The present invention provides a voice activated paper chartless medical office record keeping environment at the point of care, with access through the desktop or other device adapted for digitized audio and imaging communication, e.g., lap top computers, palm top computers, personal digital assistants, and the like, and even wireless or cell phone units with the capability of visual display having the appropriate capabilities to implement the system of the present invention.

The present invention serves to provide a number of advantages to physicians and other health care providers over existing systems, including improved clarity and accuracy in medical charting, more complete and easily accessible patient medical records, including the ability for patient accessibility in read only mode, better integration with billing functions, facilitated updates and corrections to patient records, production of standardized and customized patient tracking and treatment and billing forms in digital form, etc.

### BRIEF DESCRIPTION OF THE DRAWINGS

FIG. 1 shows a user-interface screen employed with the system of the present invention;

FIG. 2 shows a multimedia input/output screen for use with the present invention;

FIG. 3 shows a graphical output screen for utilization with the present invention.

### DETAILED DESCRIPTION OF THE PREFERRED EMBODIMENTS

The present invention provides an improvement in the combination of medical resource management and office resource management applied to the diagnosis and treatment of patients within the medical health care system. Medical resources, for purposes of this invention are defined to include items of the patient's medical record, including, e.g., personal medical history, family medical history, illness symptoms, laboratory results, diagnosis, treatment, medication and the like. In the utilization of the present invention, objectives in the management of patient medical resources are facilitated, e.g., keeping track of the patient's medical history to facilitate treatment of the patient; providing a homogeneous information database that is useful to promote the quality of care by improving the ability to analyze patient information, e.g., regarding disease symptoms and treatment and other health factors; and tracking current applicable medical technologies as indicated to be applicable to a particular patient's care regimen.

In regard to office resource management, the present invention enables the connection of patient care, billing and billing statement; insurance requirement fulfillment; office scheduling, and human resources management tasks and record keeping, which improves the effectiveness and efficiency of the office operation and reduces overall costs of providing health care to the patients.

The present invention may utilize an SQL server database engine, e.g., running SQL version 7.0 from Microsoft, and a voice recognition/dictation engine, e.g., Via Voice the IBM version of such software, or other such software and “Dragon Systems” voice recognition/dictation software. Access to the server, which can be locally resident, can be through the above reverenced computing and communication devices, and to the extent the Internet is involved through those and like devices that are html/url compatible, so as to provide access as required over the Internet to a remote server[s]. Any of a number of Internet browsers can be readily adapted as is well known in the art, to provide the required access and navigation abilities. The server database can be loaded on a personal computer, e.g., a desktop computer, laptop computer or other suitable computing engine.

The present invention facilitates medical record creation/keeping and bookkeeping. The system enables the digital storing of images, e.g., x-rays, EKG's and other records normally stored on paper, such as lab reports, medical records, treatment records, and the like. The system of the present invention also facilitates record keeping by providing tools for the conversion of normally paper records into digital form from archived records and in real time as diagnoses are performed and treatment is provided at the point of care. This in turn facilitates the analytical ability of the care provider to glean information from records in a more efficient and effective manner. The system is integrated into office management systems for the management of billings, insurance coverage, and the like, appointment and staff scheduling management, and other similar office functions. In addition, the system of the present invention enables remote access to the records by the patient or another authorized by the care provider and the patient, including insurance companies, HMO managers, other care providers and/or medical facilities, and the like, and also enables the provision to the patient of portable digitized medical history and records, e.g., for emergency use, or use when traveling and like uses. The system can provide other electronic interconnections, e.g., with pharmacies for filling and renewing prescriptions and electronic billing connection with the patient, primary and secondary insurance coverage companies, and the like. All of these can be implemented over the Internet.

Combined with an intelligent information database to provide more sophisticated analytical ability the present invention can facilitate the provision of treatment by both accumulating and analyzing medical history and medical record information to suggest possible conditions to examine, tests to run, treatments to employ and the like. This system tightly integrates the utilization of, access to and analysis of medical records and medical histories and other treatment and diagnosis tools, such as x-rays, ultrasounds, MRI's, CAT scans, lab test records, prescription drug records, etc at distant physical facilities, doctors' offices, hospitals and the like, into a real-time, 24-hour a day seven day a week medical information provision system.

The system is also integrated with state of the art human resource management systems for handling physician and staff human relations management such as payroll. vacations and holidays, overtime, employee benefits tracking, tax issues and other general accounting issues, as well as supply and asset management. One such system with which the system of the present invention is fully integrated and integrateable is “FoxMed,” a physician management product of Physician Clearing House, www.pch.com.

The present invention provides for ease of use, integration and mobility of data and data processing by utilizing a “Microsoft” “Windows”- based NT network operating system running. The operating system supports multi-tasking capabilities and simplicity of user interface, through the available icons, graphics and the like, including abilities to customize these to the tasks at hand. The available applications enabling, e.g., creation, manipulation and treatment of graphical data representations, e.g., smoothing and trending, record formats such as Subjective, Objective, Assessment, Plan (“SOAP”), digital secure signatures and other authentication/encryption, security applications, password requirements, database management, including querying, reporting, customized and data entry control, verification, audit trail, authentication and restriction, along with the familiar utilization of mouse and keyboard for navigation though the system records and functionalities, e.g., using pop-up or pull-down menus, pre-constructed forms incorporating these, and like functionalities of the operating system. This is combined with utilization of the Internet Backbone as a communication and data transfer mechanism

The system of the present invention can accommodate a variety of interfaces for data input and manipulation and utilization of the data stored in the system, e.g., palm pilots and like personal computing assistants, touch screens, voice recognition, and the like. The system can make use of health plan formulary information, drug information, e.g., PDR and can be customized to specialty as well as general practice medical practices. Access to and utilization of the system can make use of existing wireless communication technologies, both within the care providing facility and from remote locations to the location of the server[s] supporting the system. The system is compatible with a variety of web-browsers, although the graphics capabilities of some browsers may need to be enhanced to fully utilize the capabilities of the system of the present invention. The system of the present invention may be limited to the compression technologies employed on the Internet, or may be enhanced by utilizing proprietary compression techniques above and beyond those readily available over the Internet, in order to increase data flow of the data over the Internet in real time applications of the system of the present invention.

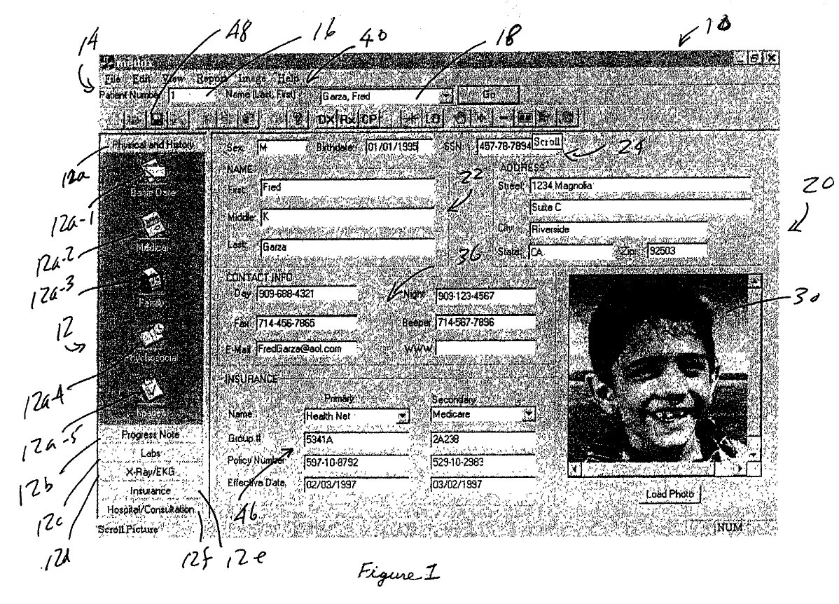

Turning now to FIG. 1, there is shown a patient information user-interface screen 10 employed with the system of the present invention. The patient information user interface screen 10 of the present invention includes a patient identification block 14 which has a patient ID number window 16 and a patient name window 18. The patient information user interface screen 10 also includes a file section 12, which can enable the selection of files pertinent to a selected patient including, e.g., History & Physical 12a, Progress Note 12b, Labs 12c, X-Ray/EKG 12d, Insurance 12e, Consultation/Hospitalization 12f. Under each of these headings is a selection of included files, e.g., under History & Physical 12a, there can be Basic Data 12a-1, Medical 12a-2, Family 12a-3, Psychosocial 12a-4 and Images 12a-5, as examples. When a user selects, e.g., the Images 12a-5 icon, the system allows the user to scan raw data into the system. The raw data subsequently can be categorized into each section, i.e. Basic Data, Medical, Family, and Psychosocial. With the Basic Data file selected as by clicking on the Basic Data file icon 12a-1 shown in FIG. 1, the right hand side of the user interface screen 10 will then be caused by the system to contain an input/output section 20. The input/output section 20 can be used by the user, e.g., by the physician or staff to input/edit the patient information displayed. This can be protected with suitable security measures, e.g., through appropriate password and other security features known in the art. The patient information user-interface screen 20 can include a patient name section 22 with blocks for entering, and later recalling and reading, e.g., the patient's first name, middle initial and last name. Also included is a patient data section 24, which can include, e.g., blocks for the sex, birth date and Social Security Number of the patient. Also included is a patient contact information section 36, which can contain a block for identifying the work and home phone numbers for the patient, and a FAX number, a pager number and e-mail address, as applicable. Also included can be an insurance information section 36, which can contain blocks for entering, and subsequently recalling and reading, information about the primary and secondary insurance carriers for the patient, including the name, group number, insurance ID and effective date. With the appropriate security authentication, e.g., password, PIN or the like, a user can be permitted to enter into the various blocks of the information for a new patient, which can be assigned a new patient ID number in block 16 by the system automatically, and which will then serve to update the database utilized with the present invention accordingly. When the information is completed or a subsequent editing of the information is completed, the user can, by clicking on the save icon 48, update the database with the newly entered or modified information. The input/output section 20 can also include a photographic ID section 30 into which can be loaded by known means a digital photographic identification of the patient.

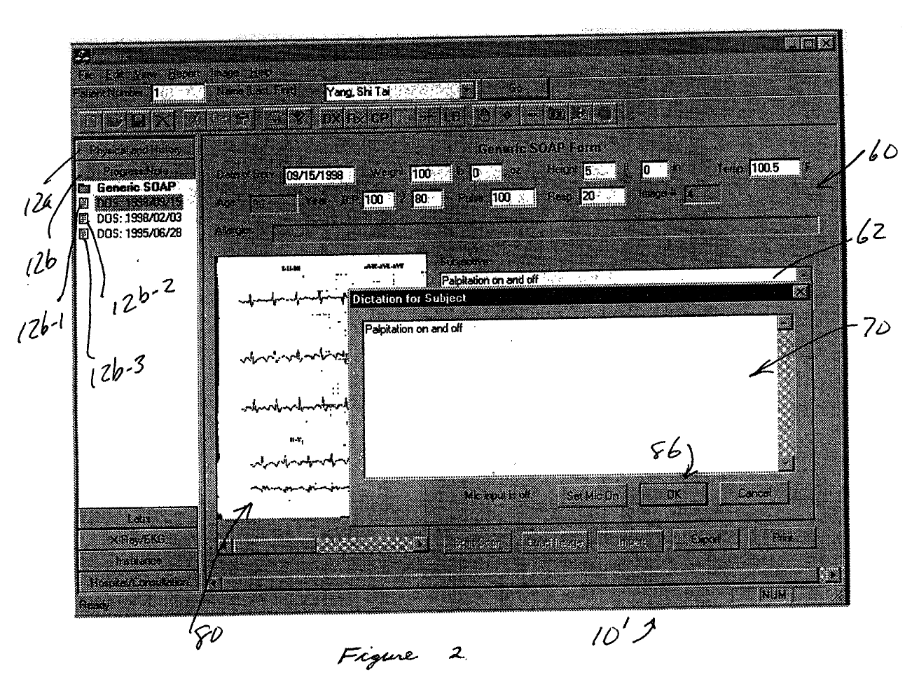

Turning now to FIG. 2 there is shown a multimedia input/output screen 10′ according to the present invention. This screen is utilized to convert analog data (e.g., a scanned image) into digital data for storage and manipulation. Dictation through voice recognition software and/or input through typing, pull down menus, hand writing recognition systems, etc. can be employed here to facilitate the preparation of SOAP records of analog files or of input regarding files and other information already digitally stored in the system. The scanned and stored information can include hand scripts, photos, x-rays, MRIs and like images, etc. for later retrieval. As shown in FIG. 2, when the user selects the Progress Note section 12b, there can be displayed, e.g., a plurality of Generic SOAP images 12b-1 to 12b-3. Selecting one of these, e.g., 12b-1 by the user brings up on the right hand portion of the screen a medical chart window 80 in which is displayed, e.g., a digitally stored image of, e.g., an EKG. This image can be scrolled through the chart window 80 manually or automatically as the health care provider inputs, by any of the above noted methods comments about the visually displayed chart information, which can then be stored with the chart as part of the medical records. The present invention thus facilitates the conversion of raw data (i.e. images) into more meaningful text format, e.g., useful for research and statistical analysis, while also preserving the original raw data for other purposes. The screen also has a section 60 for recording the information about the patient's latest visit, e.g., the date, patient weight, height, temperature, blood pressure, pulse rate and respiratory rate, age and the image number. This information can be used when loading a new image into the section 80 as by scanning, copying, downloading, video capturing, etc. The screen 10′ also has a section 62 for SOAP to be input, e.g., about the patient's visit or the image being viewed in the chart window 80, and a similar section 62 for input of subjective, objective, assessment and plan (SOAP) information. A dictation window 70 can be used to view the dictated words and edit them prior to input into the medical records stored in the system, e.g., through the SOAP input section 62. The dictation window 70 has associated with it function buttons 86 for turning on the dictation microphone, inputting the dictated comments, e.g., into the SOAP, EKG or x-ray report.

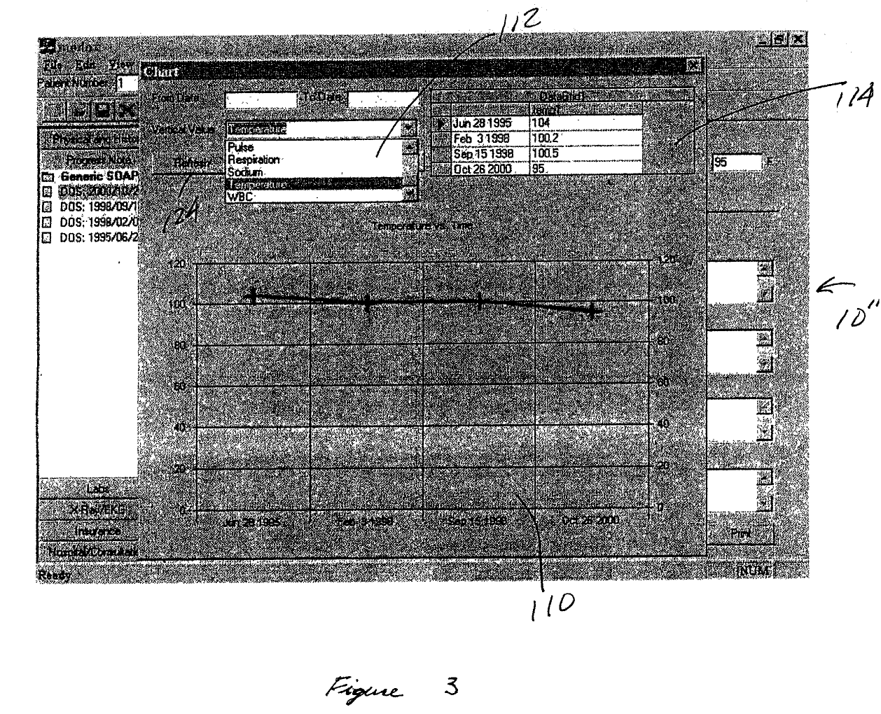

Turning now to FIG. 3, there is shown a chart graphing input/output user interface screen 10″ for construction and displaying, e.g., chart trend graphs, taking information from data fields, such as patient vital signs, from, e.g., on a series of treatment visits. The screen can have a chart section 110, which can display a visual representation of the trend being charted, a chart parameters section 112, which can indicate, e.g., the scope of the graphed information in time, the value being graphically charted and a function button 124 for Refresh. The screen can also have a data charted section 114, which lists the graphically illustrated datum points.

As explained above, the medical office management system of the present invention facilitates the management of a total medical practice environment with one click easy access the user, physician, staff person or patient, or secondary care provider, hospital emergency room person, etc. may move seamlessly from patient care information to such information as accounting and scheduling, accessing all available files and records, including acute and chronic data. The system favors transfer paper medical records into paperless environment painlessly also allows the patients to download their records for personal viewing and to upload their information to a separate location. The paperless charting system consists of a secure and tamper resistant system for the electronic data transfer, including, e.g., over the Internet and on personal digital data storage media, facilitating an integrated system for more effective and efficient ambulatory care, and for preventing medical errors.

We claim:

1. A medical care management system having a database of patient information including medical history records, comprising:
a medical record input apparatus;
a medical record storage apparatus;
a medical record viewing apparatus;
a means for automatically scrolling the medical record being displayed by the medical record viewing apparatus;
a comment input apparatus receiving comments from a user of the system relating to the medical record being displayed, and inputting the comments into the medical records storage apparatus linked to the medical record being displayed.

2. The system of claim 1, further comprising:
a patient information input information apparatus;
linking means for linking the patient information to at least one stored medical record.

3. The system of claim 2, wherein the medical record comprises an electronic image of an analog or physical record.

4. The system of claim 3, wherein the analog or physical record includes a record previously created in corporeal form.

5. The system of claim 3, wherein the analog or physical record includes a previously remotely created electronic version of a record originally created in corporeal form.

6. The system of claim 2, wherein the medical record comprises a copy of a remotely created electronic image of the medical record.

7. The system of claim 2, wherein the patient information input apparatus is a dictation system employing voice recognition software.

8. The system of claim 4 wherein the medical record is displayed in a window as part of a video display generated by a computing engine in communication with the medical record storage apparatus.

9. The system of claim 5 wherein the medical record is displayed in a window as part of a video display generated by a computing engine in communication with the medical record storage apparatus.

10. The system of claim 5 wherein the medical record is displayed in a window as part of a video display generated by a computing engine in communication with the medical record storage apparatus.

11. A method of providing medical care management utilizing a database of patient information including medical history records, comprising:
storing medical records in the database in electronic form;
providing a display of a view of the stored medical record;
scrolling the view of the medical record being displayed;
receiving and recording a comment from a viewer relating to the medical record being displayed, and inputting the comment into the database linked to the medical record being displayed.

12. The method of claim 11, further comprising:
inputting patient information into the database linked to at least one stored medical record.

13. The method of claim 12, wherein the medical record comprises an electronic image of an analog or physical record.

14. The method of claim 13, wherein the analog or physical record includes a record previously created in corporeal form.

15. The method of claim 13, wherein the analog or physical record includes a previously remotely created electronic version of a record originally created in corporeal form.

16. The method of claim 12, wherein the medical record comprises a copy of a remotely created electronic image of the medical record.

17. The method of claim 12, wherein the step of receiving and recording includes recording dictation into text through the use of voice recognition software.

18. The method of claim 14 including the step of displaying the medical record in a window as part of a video display generated by a computing engine in communication with the medical record storage apparatus.

19. The method of claim 15 including the step of displaying the medical record in a window as part of a video display generated by a computing engine in communication with the medical record storage apparatus.

20. The method of claim 5 including the step of displaying the medical record in a window as part of a video display generated by a computing engine in communication with the medical record storage apparatus.

21. A medical care management system having a database of patient information including medical history records, comprising:
a medical record input apparatus;
a medical record storage apparatus;
a medical record viewing apparatus;
a means for automatically scrolling the medical record being displayed by the medical record viewing apparatus;
a comment input apparatus receiving comments from a user of the system relating to the medical record being displayed, and inputting the comments into the medical records storage apparatus linked to the medical record being displayed;
a means for securely moving the medical record by the medical record storage apparatus.

22. A medical care management system having a database of patie nt information including medical history records, comprising:
a medical record input apparatus;
a medical record storage apparatus;
a medical record viewing apparatus;
a means for automatically scrolling the medical record being displayed by the medical record viewing apparatus;
a comment input apparatus receiving comments from a user of the system relating to the medical record being displayed, and inputting the comments into the medical records storage apparatus linked to the medical record being displayed;
a means for linking automatic scrolling of the medical record to the operation of the comment input apparatus.

23. A medical care management system having a database of patient information including medical history records, comprising:
a medical record input apparatus;
a medical record storage apparatus;
a medical record viewing apparatus;
a means for automatically scrolling the medical record being displayed by the medical record viewing apparatus;
a comment input apparatus receiving comments from a user of the system relating to the medical record being displayed, and inputting the comments into the medical records storage apparatus linked to the medical record being displayed;
a means for linking automatic scrolling of the medical record to the operation of a voice dictation apparatus comprising a part of the comment input apparatus.

24. A medical care management system having a database of patient information including medical history records, comprising:
a medical history record input apparatus;
a medical history record storage apparatus;
a medical history record viewing apparatus;
a means for securely moving a medical history record to and from the medical history record storage apparatus;
means for activating automatic scrolling of the medical record on the medical history record viewing apparatus in response to a voice command input the medical history record input apparatus.
